(19) United States
(12) Patent Application Publication
(10) Pub. No.: US 2026/0203377 A1
(43) Pub. Date: Jul. 16, 2026

(54) COMBINING LARGE LANGUAGE MODEL WITH RULES ENGINE PROCESSING

(71) Applicant: Intuit Inc., Mountain View, CA (US)

(72) Inventors: Vishal Kumar SINGH, Bengaluru (IN); Murari LAL, Bangalore (IN); John SAMUEL, Bengaluru (IN); Srivathsal VENKATARAMU, Bangalore (IN); Sanjay KUMAR, Bangalore (IN); Sandeep MEWARA, Bengaluru (IN)

(73) Assignee: Intuit Inc., Mountain View, CA (US)

(21) Appl. No.: 19/026,187

(22) Filed: Jan. 16, 2025

(51) Int. Cl. G06F 18/2413

(52) U.S. Cl. CPC G06F 18/2413

(57) ABSTRACT

Combining a large language model (LLM) with rules engine processing includes obtaining a document, extracting a set of attributes from the document to obtain a set of extracted attributes, and selecting, from government rules, a set of government rules based on the set of extracted attributes. The method further includes the LLM processing the set of extracted attributes and the set of government rules to obtain an LLM identified class for the document. A rules engine applying software rules corresponding to the government rules processes the set of extracted attributes according to the LLM identified class to obtain a government rule defined amount. The government rule defined amount is presented.

### BACKGROUND

Large Language Models (LLMs) are a type of artificial intelligence system that is trained on vast amounts of data in order to understand natural language and generate natural language responses. However, errors in processing by the LLMs may cause the LLMs to generate false responses or hallucinations. Hallucinations can be difficult, if not impossible, to detect without a human analyzing all of the input data, which counteracts the benefits of using an LLM. In certain tasks, such as applying government rules to data, accuracy is important. Therefore, in such tasks, hallucinations by the LLM cause the LLM to be inadequate for performing the task.

### SUMMARY

In general, in one aspect, one or more embodiments relate to a method that includes obtaining a document, extracting a set of attributes from the document to obtain a set of extracted attributes, and selecting, from government rules, a set of government rules based on the set of extracted attributes. The method further includes a large language model (LLM) processing the set of extracted attributes and the set of government rules to obtain an LLM identified class for the document. A rules engine applying software rules corresponding to the government rules processes the set of extracted attributes according to the LLM identified class to obtain a government rule defined amount. The government rule defined amount is presented.

In general, in one aspect, one or more embodiments relate to a system that includes one or more computer processors. The system further includes a data extractor executing on the one or more computer processors and configured to extract a set of attributes from a document to obtain a set of extracted attributes, a LLM prompt generator executing on the one or more computer processors and configured to select, from government rules, a set of government rules based on the set of extracted attributes, and an LLM executing on the one or more computer processors and configured to process the set of extracted attributes and the set of government rules to obtain an LLM identified class for the document. The system further includes a rules engine executing on the one or more computer processors and configured to process, by applying software rules corresponding to the government rules, the set of extracted attributes according to the LLM identified class to obtain a government rule defined amount, and a user interface configured to present the government rule defined amount.

In general, in one aspect, one or more embodiments relate to a non-transitory computer readable medium comprising computer readable program code for causing a computing system to perform operations. The operations include obtaining a document, extracting a set of attributes from the document to obtain a set of extracted attributes, selecting, from government rules, a set of government rules based on the set of extracted attributes, and processing, by an LLM, the set of extracted attributes and the set of government rules to obtain an LLM identified class for the document. The operations further include processing, by a rules engine applying software rules corresponding to the government rules, the set of extracted attributes according to the LLM identified class to obtain a government rule defined amount and presenting the government rule defined amount.

Other aspects of one or more embodiments will be apparent from the following description and the appended claims.

### BRIEF DESCRIPTION OF DRAWINGS

FIG. 1 shows a system in accordance with one or more embodiments.

FIG. 2 shows a flowchart in accordance with one or more embodiments.

FIG. 3 shows an example in accordance with one or more embodiments.

FIG. 4A and FIG. 4B show a computing device in accordance with one or more embodiments.

Like elements in the various figures are denoted by like reference numerals for consistency.

### DETAILED DESCRIPTION

One or more embodiments are directed to overcoming hallucinations by a large language model (LLM) when selecting and applying government rules to a document. Specifically, one or more embodiments combine the LLM with a rules based engine. The LLM performs classification tasks of selecting a government rule to apply, and determining the class as defined by the government rule. The rules based engine determines an amount associated with the document as defined by the government rule. By using the LLM to perform the selection and classification tasks, and the rules engine to perform the amount determination, embodiments combine the advantages of both into a cohesive framework. Specifically, the lower rigidity of the LLM allows the LLM to handle a variety of documents when selecting the government rule and the class. With the consistency aspect of the rules based engine, using the rules based engine to determine the amount overcomes the hallucinations of the LLM.

By way of a more specific example, United States Tax Statutes and Regulations form an extremely complex set of government rules. The selection of which government rules may apply to which user document that records expenses is not trivial. Moreover, some government rules specify that certain expenses of an entity should be classified as a credit while other expenses are a deduction. The government rules are also complex in terms of the amount of credit and the amount of the deduction. In the example, the LLM selects the government rule and classifies the document as corresponding to an expense that is a credit or an expense that is a deduction. The rules based engine applies the government rule to determine the amount of the credit or the amount of the deduction. The LLM may then generate a summary for a user detailing the classification and the amount.

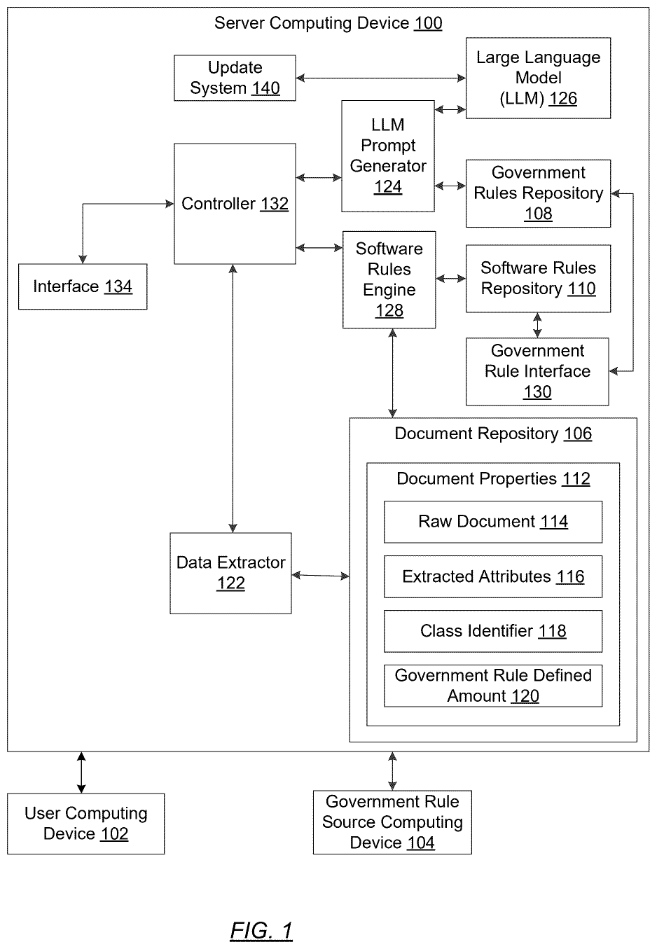

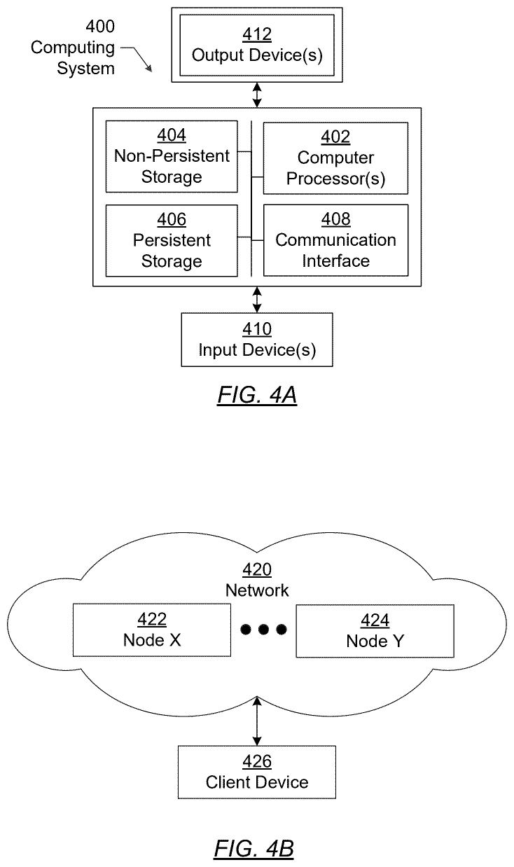

Attention is now turned to the figures. FIG. 1 shows a system, in accordance with one or more embodiments. The system includes a server computing device (100) connected to a user computing device (102) and a government rule source computing device (104). The user computing device (102) and government rule source computing device (104) are computing systems, such as shown in FIG. 4A and FIG. 4B. The user computing device (102) is a computing device of a user. The user computing device (102) may be configured to display a user interface for a user. For example, the interface may be in a browser or other application that is displayed on a display device. The user computing device (102) may be configured to provide documents that may record expenses. In some embodiments, multiple user computing devices may exist. For example, one user computing device may have documents and another user computing device may display the user interface. The user computing device having the documents may be owned or controlled by a third party, such as a server.

The government rule source computing device (104) is a computing device that stores government rules. For example, the government rules may include the statutes, regulations, and other government publications. The government rule source computing device (104) may be one or more computers that provide for the downloading of the government rules.

A server computing device (100) is a computing system, such as described in FIG. 4A and FIG. 4B. The server computing system (100) is configured to obtain documents from the user computing device (102) and transmit the interface to the user computing device (102). The server computing device (100) is further configured to obtain the government rules from the government rule source computing device (104).

The server computing device (100) includes various data repositories (e.g., document repository (106), government rules repository (108), software rules repository (110)). In general, a data repository (106) is a type of storage unit or device (e.g., a file system, database, data structure, or any other storage mechanism) for storing data. The various data repositories (106) may include multiple different, potentially heterogeneous, storage units and/or devices.

The document repository (106) includes the functionality to store document properties (112) for each document. Although only a single document is shown, the document repository (106) may store millions or even more documents. Document properties (112) include a raw document (114), extracted attributes (116), a class identifier (118), and a government rule defined amount (120).

The raw document (114) is the document as provided to the server computing device (100). For example, the raw document (114) may be an image form of the document, such as a scanned document. As another example, the raw document (114) may be a structured or unstructured document whereby the values in the document are not related to a description as to what the values represent.

The extracted attributes (116) are attributes that are extracted from the document. The extracted attributes (116) are values that are within the document or from the metadata of the document. Attributes may be in the form of key value pairs. The key is the attribute name describing the attribute and the value is the value extracted from the document. For example, the attribute may be a date, a description, amount on the document, a title of the document, or other attributes extracted from the document.

The class identifier (118) is a class assigned to the document based on government rules. The class identifier (118) is not defined in the document or the metadata of the document but is rather determined from government rules applied to the document attributes. Multiple class identifiers may be associated with the document, such as in the case whereby a single document has multiple government rules applicable. For example, in the case of an invoice and the government rule being tax rules, some of the expenses in the invoice may be a credit and other expenses may be a deduction.

The government rule defined amount (120) is an amount for the document as defined by the government rule. Specifically, when the government rule is applied to the attributes in the document, the government rule specifies a certain amount. The amount may be a value within the document, less than a value within the document, or a value within the government rule. As another example, the amount may be determined from an equation in the government rule that uses as input a value from the document.

Continuing with the data repositories, the government rules repository (108) is a data repository that stores government rules. A government rule is a statute, regulation, or official guidance from a government agency. The government rules repository (108) may store all government rules that are related to a particular agency. For example, the government rule repository may store the United States Tax Code as well as regulations and Internal Revenue Service Notices. As another example, the government rule repository may store a subsection of the United States Tax Code that are for businesses. In one or more embodiments, the government rules are stored in natural language form in the government rules repository (108). For example, the government rules may be stored as the raw version as published by the government entity, as an eXtensible Markup Language version, or other such version that is human readable.

The software rules repository (110) is a data repository that is configured to store software rules. Software rules are a collection of software instructions that are executable by the computer system. The software rules specify how to calculate the government rule defined amount (120) for the document. The software rules are rules that are generated from the government rules. For example, a regulation that the 3% value of the particular type of item up to $ 2000 may be used as a deduction for a business owner may be changed to a software rule that is a set of if-then statements (e.g., if business owner and particular type of item is X, and if 3% multiplied by the value is less than $ 2000, then amount is 3% multiplied by the value, otherwise amount is $2000.). Software rules may be configured to use the extracted attributes (116) from the document as input. The software rules may also be configured to use external data, such as from an account of a user, as input.

The government rules repository (108) and the software rules repository (110) may be populated via a government rule interface (130) based on government rules. The government rules interface (130) is an interface that is configured to interact with the government rule source computing device (104). For example, the government rules interface (130) may be a job that periodically obtains new government rules.

Continuing with the server computing device (100), the server computing device (100) also includes a data extractor (122), a LLM prompt generator (124) connected to an LLM (126), a software rules engine (128), a controller (132), an interface (134), and an update system (140). Each of these components is described below.

The data extractor (122) includes functionality to extract data from the document to generate extracted attributes. For example, the data extractor (122) may include an optical character recognition (OCR) engine that is configured to transform the image version of a document to a text based version of the document. The data extractor (122) may also include one or more machine learning models, such as a convolutional neural network or a recurrent neural network, to extract key value pairs for each of the values in the document. The data extractor (122) may also include a storage interface to store the key value pairs as extracted attributes (116).

The LLM prompt generator (124) is configured to generate a prompt to the LLM (126) for requesting the matching. For example, the LLM prompt generator (124) may gather all or a portion of the government rules in the government rule repository and add the government rules with the extracted attributes to a prompt template that includes an instruction to perform the classification. The LLM prompt generator (124) may include a retrieval augmented generator (RAG) system that is configured to select a subset of government rules that may potentially be matching. For example, the RAG system may include a vector database that has vector embeddings of the government rules. The RAG system may also include a vector embedding model that includes the functionality to generate vector embeddings of the extracted attributes. The RAG system may further be configured to compare the respective vector embeddings to select the subset of government rules.

The LLM prompt generator (124) is connected to an LLM (126). The LLM (126) is a type of artificial intelligence (AI) program that performs natural language processing to recognize and generate text, images, and other content. The LLM (126) may have hundreds of thousands to trillions of parameters. Examples of LLMs include versions of ChatGPT®, Llama®, Mistral-7B®, and proprietary LLMs, etc. The LLM may be a general LLM that is generally trained to perform a variety of natural language processing tasks. In such an example, the LLM prompt may include one-shot examples of classifications. In another example, the LLM may be a specific LLM that is a specifically trained LLM. A specifically trained LLM is an LLM that is generally trained to recognized text and then specifically trained to perform a particular task. In the present example, the specifically trained LLM may be specifically trained to perform the classification or summarization tasks. In some embodiments multiple LLMs may exist, whereby one LLM is configured to perform the classification and another LLM is configured to perform the summarization. For example, the summarization LLM may be a generally or specifically trained LLM.

The software rules engine (128) is a set of computer instructions that are configured to apply the software rules in the software rules repository (110) to the extracted attributes (116).

The controller (132) is configured to control the operations of the server computing device (100). For example, the controller (132) may trigger the storage and processing of the document through the LLM prompt generator (124) and the software rules engine (128). In some embodiments, the controller (132) is part of a user level application through which the user may interact. As another example, the controller may be configured to interface with a user level application.

The interface (134) may be a user interface or application programming interface that is configured to receive documents and display results to the user. Further, the interface (134) may be configured to receive feedback from the user.

The update system (140) is software configured to update the various components of the server computing system. For example, the update system (140) may be configured to train and further train the server computing system.

While FIG. 1 shows a configuration of components, other configurations may be used without departing from the scope of one or more embodiments. For example, various components may be combined to create a single component. As another example, the functionality performed by a single component may be performed by two or more components.

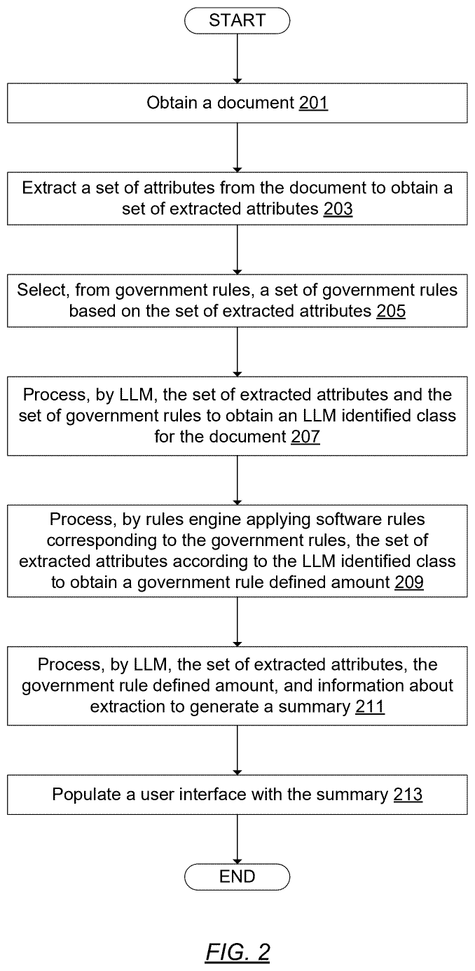

FIG. 2 shows a flowchart in accordance with one or more embodiments. The method of FIG. 2 may be implemented using the system of FIG. 1 and one or more of the steps may be performed on or received at one or more computer processors. While the various steps in this flowchart are presented and described sequentially, at least some of the steps may be executed in different orders, may be combined or omitted, and at least some of the steps may be executed in parallel. Furthermore, the steps may be performed actively or passively.

In Block 201, a document is obtained. The document may be obtained from a user interface, such as if the user uploads the document or from a user document repository.

In Block 203, a set of attributes from the document is extracted to obtain a set of extracted attributes. If the document is in image format, an OCR engine may process the document to identify individual characters and words. Based on proximity, term library and other characteristics of the document, the OCR engine may identify terms or phrases in the document. The OCR engine may output bounding boxes around the terms or phrases. Linearity between bounding boxes, distance, lines, and other characteristics may be used to identify relationships, including tables, between terms in different bounding boxes. Convolutional neural networks or recurrent neural networks may also be used on the document to identify relationships between terms. From the relationships and the format of the terms themselves, the attribute names and the attribute values are extracted from the document. Metadata, such as the file name, the date of the file, and other information may also be added as attributes of the document. The extracted attributes from the document and the metadata form the set of attributes.

In Block 205, a set of government rules is selected based on the set of extracted attributes. The set of government rules is obtained from the government rules repository. In one or more embodiments, the RAG system uses, as input, the set of extracted attributes to generate vector embeddings. The RAG system may also use account information of the user, such as the type of user or other information about the user that may be used to identify the government rules. The RAG system may compare the vector embeddings to the vector embeddings of the government rules. Government rules that have vector embeddings within a threshold degree of the attributes may be selected. Not all the government rules that are selected are relevant to the determination. Namely, the set selected is a superset of applicable government rules.

In Block 207, an LLM processes the set of extracted attributes and the set of government rules to obtain an LLM identified class for the document. The LLM prompt manager sends the selected government rules with the set of extracted attributes in an LLM prompt to the LLM. The instructions instruct the LLM to classify the document based on the LLM prompt. The LLM processes the set of extracted attributes through a series of neural network layers with the government rules to generate the classification. Because LLMs are trained on large volumes of data to understand natural language, and then further trained to perform classifications based on applying a government rule, the LLM is able to select the applicable government rule and then apply the government rule with a credit or deduction. The output of the LLM is the LLM identified class and a confidence value identifying the confidence in the LLM identified class. The LLM may also output an identifier of the government rule applied. In some cases, the LLM applies multiple government rules, and thus may output the identifiers of the multiple government rules.

In Block 209, a rules engine applies software rules corresponding to the government rules to process the set of extracted attributes according to the LLM identified class to obtain a government rule defined amount. The rules engine may use the identifier of the government rule applied to obtain the software rule corresponding to the government rule from the software rules repository. The rules engine may then process the software rule with the extracted attributes to determine the government rule defined amount for the document. The rules engine outputs the government rule defined amount. By using the combination of the rules engine and the LLM, embodiments overcome the respective defects of each. Namely, the inability of the rules engine to handle sets of previously unseen attributes or classify based on a variety of government rules is overcome by the LLM performing such processing. Similarly, the rules engine use prevents the LLM hallucinating the government rule defined amount.

In Block 211, the LLM processes the set of extracted attributes, the government rule defined amount, and information about extraction to generate a summary. An LLM prompt is sent to the LLM that requests a natural language summary of the classification and government defined amount. The LLM prompt includes the set of extracted attributes, the government rule defined amount, and information about extraction. The LLM uses the output of the rules engine along with the extracted attributes, and other information to generate the summary. For example, the other information may include the one or more government rules that are applied. The summary may include a description of the government rule, a description explaining why the government rule applies, an identifier or link to the government rule, the government rule defined amount and the class identifier.

In Block 213, a user interface is populated with the summary. The summary is transmitted to the user computing device, which displays the summary on a user display. The summary may also or alternatively be stored in a data repository. When viewing the summary, the user may determine that the LLM did not correctly identify the government rule or that the classification is incorrect given the government rule. In such a scenario, the user provides feedback. The feedback is used to further train the LLM.

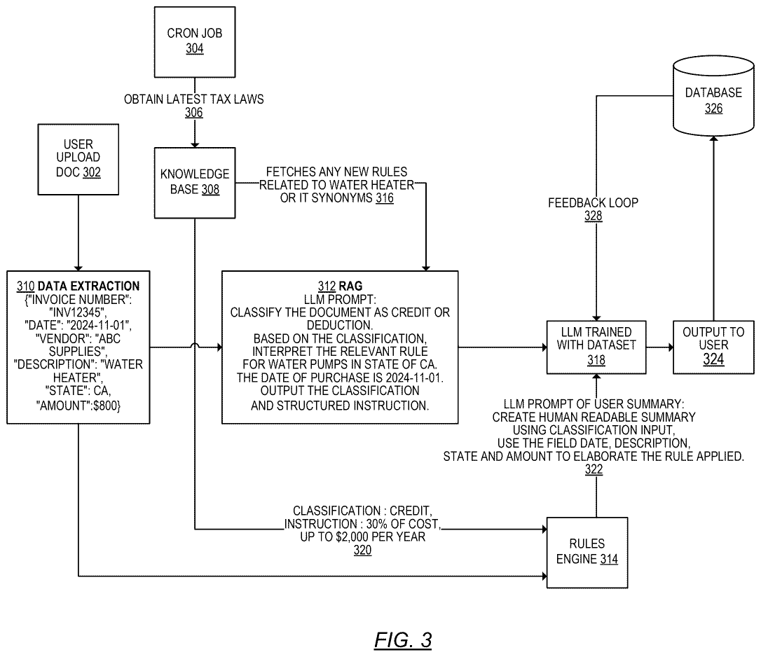

FIG. 3 shows an example in accordance with one or more embodiments. The following example is for explanatory purposes only and not intended to limit the scope of one or more embodiments.

In the example, consider the scenario in which embodiments are applied to classifying documents into a binary class for credit or deduction based on whether the expense recorded on the document is for a credit or for a deduction. If an accountant is unaware that an expense can be used as credit or deduction, the lack of awareness can lead to losses for the taxpayer. For example, if a taxpayer purchases a solar panel, but fails to mention the solar panel to their accountant or if the accountant is unaware of the residential clean energy credit, a loss exists for the taxpayer.

In one or more embodiments, a user can enter the data related to expenses manually and specify which commodity was purchased, or the user can upload all the documents related to the user's single purchase or all purchases. RAG may be used to obtain recent changes in rules and regulations from the Internal Revenue Service regarding credits and deductions. The information is then passed to the LLM to classify the expense as a credit or deduction. In some cases, a trinary classification is performed to set whether the expense is a credit, a deduction, or neither. A summary is provided to the end user, stating which expenses can be classified as credits or deductions, under which rule and regulation of the Internal Revenue Service.

In the example below, consider the scenario in which the user is a business buying a water heater. Periodically, using a Cron job (304), latest tax laws are obtained (306) and populated into a knowledgebase (308). A user uploads a document (302). The user uploading the document may trigger data extraction (310) from the document.

Data extraction (310) may involve executing an OCR engine to identify individual terms. Further, a data extraction model may be used to relate the terms and extract key value pairs. In the example, the key value pairs include an (“Invoice Number”: “INV12345”), (“Date”: “2024Nov. 1”), (“Vendor”: “ABC Supplies”), (“Description”: “Water Heater”), (“State”: CA), and (“Amount”: $800).

The key value pairs are passed to a RAG system (312) and a rules engine (314). The RAG system (312) processes the key value pairs to obtain one or more vector embeddings of one or more parts of the key value pairs. The RAG system (312) fetches any new rules related to water heaters or its synonyms (316).

The RAG system (312) generates an LLM prompt using the rules. The LLM prompt is “Classify the Document as credit or deduction. Based on the classification, interpret the relevant rule for water pumps in state of CA. The Date of purchase is 2024Nov. 1. Output the classification and structured instruction.”

The RAG system (312) passes the LLM prompt to the LLM that is specifically trained with a dataset (316). The LLM classifies the document as being for a credit or deduction. In the example, the classification is that the document is a credit. The result of the classification is passed to a rules engine (314). The rules engine (314) applies software rules generated from government rules. For example, the software rule is that for a credit classification, 30% of the cost up to $ 2000 per year may be applied as a credit (320).

The LLM trained with the dataset (318) is then called to generate a summary. The prompt to the LLM for the summary is “Create human readable summary using classification input, use the field date, description, state and amount to elaborate the rule applied.” (322).

The LLM generates a summary. The summary is transmitted as output to the user (324). The summary may also be stored in a database (326). Any feedback from the user or third parties are provided as part of a feedback loop (328) to further train the LLM (318).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a document;
extracting a set of attributes from the document to obtain a set of extracted attributes;
selecting, from a plurality of government rules, a set of government rules based on the set of extracted attributes;
processing, by a large language model (LLM), the set of extracted attributes and the set of government rules to obtain an LLM identified class for the document;
processing, by a rules engine applying a plurality of software rules corresponding to the plurality of government rules, the set of extracted attributes according to the LLM identified class to obtain a government rule defined amount; and
presenting the government rule defined amount.

2. The method of claim 1, further comprising:
processing, by the LLM, the set of extracted attributes and the government rule defined amount to generate a summary; and
populating a user interface with the summary.

3. The method of claim 2, wherein the summary comprises a description of a government rule in the set of government rules that is used to determine the LLM identified class, a description explaining why the government rule applies, and the government rule defined amount.

4. The method of claim 1, further comprising:
generating one or more vector embeddings of the set of extracted attributes; and
selecting the set of government rules by comparing the one or more vector embeddings with a plurality of vector embeddings in a vector database, wherein the plurality of vector embeddings is generated from the plurality of government rules.

5. The method of claim 1, further comprising:
specifically training a general LLM to perform classifications based on the plurality of government rules and a plurality of attributes to generate a specifically trained LLM,
wherein the specifically trained LLM processes the set of extracted attributes and the set of government rules.

6. The method of claim 1, wherein the document is an image document and wherein extracting the set of attributes comprises processing the document by an optical character recognition (OCR) engine to extract the set of attributes.

7. The method of claim 1, further comprising:
periodically populating a government rule repository with new government rules as the new government rules are received.

8. The method of claim 1, further comprising:
receiving feedback from a user; and
further training the LLM based on the feedback.

9. A system comprising:
one or more computer processors;
a data extractor executing on the one or more computer processors and configured to extract a set of attributes from a document to obtain a set of extracted attributes;
a large language model (LLM) prompt generator executing on the one or more computer processors and configured to select, from a plurality of government rules, a set of government rules based on the set of extracted attributes;
an LLM executing on the one or more computer processors and configured to process the set of extracted attributes and the set of government rules to obtain an LLM identified class for the document;
a rules engine executing on the one or more computer processors and configured to process, by applying a plurality of software rules corresponding to the plurality of government rules, the set of extracted attributes according to the LLM identified class to obtain a government rule defined amount; and
a user interface configured to present the government rule defined amount.

10. The system of claim 9, wherein:
the LLM is further configured to process the set of extracted attributes and the government rule defined amount to generate a summary, and
the user interface is further configured to display the summary.

11. The system of claim 10, wherein the summary comprises a description of a government rule in the set of government rules that is used to determine the LLM identified class, a description explaining why the government rule applies, and the government rule defined amount.

12. The system of claim 9, wherein the LLM prompt generator is further configured to:
generate one or more vector embeddings of the set of extracted attributes; and
select the set of government rules by comparing the one or more vector embeddings with a plurality of vector embeddings in a vector database, wherein the plurality of vector embeddings is generated from the plurality of government rules.

13. The system of claim 9, further comprising:
an update system configured to specifically train a general LLM to perform classifications based on the plurality of government rules and a plurality of attributes to generate a specifically trained LLM,
wherein the specifically trained LLM processes the set of extracted attributes and the set of government rules.

14. The system of claim 9, wherein the document is an image document and wherein extracting the set of attributes comprises processing the image document by an optical character recognition (OCR) engine to extract the set of attributes.

15. The system of claim 9, further comprising:
a government rule interface configured to periodically populate a government rule repository with new government rules as the new government rules are received.

16. The system of claim 9, wherein the system is further configured to:
receive feedback from a user, and
further train the LLM based on the feedback.

17. A non-transitory computer readable medium comprising computer readable program code for causing a computing system to perform operations comprising:
obtaining a document;
extracting a set of attributes from the document to obtain a set of extracted attributes;
selecting, from a plurality of government rules, a set of government rules based on the set of extracted attributes;
processing, by a large language model (LLM), the set of extracted attributes and the set of government rules to obtain an LLM identified class for the document;
processing, by a rules engine applying a plurality of software rules corresponding to the plurality of government rules, the set of extracted attributes according to the LLM identified class to obtain a government rule defined amount; and
presenting the government rule defined amount.

18. The non-transitory computer readable medium of claim 17, wherein the operations further comprise:
processing, by the LLM, the set of extracted attributes and the government rule defined amount to generate a summary; and
populating a user interface with the summary.

19. The non-transitory computer readable medium of claim 18, wherein the summary comprises a description of a government rule in the set of government rules that is used to determine the LLM identified class, a description explaining why the government rule applies, and the government rule defined amount.

20. The non-transitory computer readable medium of claim 17, wherein the operations further comprise:
generating one or more vector embeddings of the set of extracted attributes; and
selecting the set of government rules by comparing the one or more vector embeddings with a plurality of vector embeddings in a vector database, wherein the plurality of vector embeddings is generated from the plurality of government rules.
